(19) United States
(12) Patent Application Publication
(10) Pub. No.: US 2013/0271286 A1
(43) Pub. Date: Oct. 17, 2013

(54) Methods and Systems for Monitoring Environmental Conditions Using Wireless Sensor Devices and Actuator Networks

(71) Applicants: Zhi Quan, Livermore, CA (US); Shuguang Cui, College Station, TX (US)

(72) Inventors: Zhi Quan, Livermore, CA (US); Shuguang Cui, College Station, TX (US)

(21) Appl. No.: 13/856,377

(22) Filed: Apr. 3, 2013

Related U.S. Application Data
(60) Provisional application No. 61/624,252, filed on Apr. 14, 2012.

(51) Int. Cl. G08B 5/00

(52) U.S. Cl. CPC G08B 5/00
USPC 340/691.6

(57) ABSTRACT

The present invention comprises methods and systems of a network of sensor devices to monitor environmental conditions. Each sensor device is capable of acquiring environmental data and transmitting the data to a central controller of a networking system by wireless communication. By processing the environmental data obtained from the geographically deployed sensor devices, the central controller is capable of detecting a trend of the hazardous condition. The central controller generates early warning signals based on the hazardous levels of the physical or environmental conditions, as well as the trend of such conditions. When receiving a high level of hazardous conditions from one of the networked sensor devices, the central controller can compare the results with neighboring sensor devices to determine whether the signal received is due to a hazard leakage or a sensor device malfunction, so to reduce false alarms and provide feedbacks to communication devices networked in the system.

### CROSS REFERENCE TO RELATED APPLICATION

This application claims priority to a U.S. Provisional Application, No. 61/624,252, filed on Apr. 14, 2012, which is incorporated herein by reference.

### TECHNICAL FIELD OF THE INVENTION

The present invention relates generally to a system and a method for monitoring hazardous environmental conditions and generating early warning signals when a trend of a certain hazardous condition is detected or when a potential tool or equipment is malfunctioned.

### BACKGROUND OF THE INVENTION

Early notification and warning of hazardous conditions or equipment malfunctions in work environments can be very helpful for operators to react to the hazardous conditions or the equipment malfunctions. Early warning is particularly important for processes and pipelines in oil refineries, mine ventilation systems, power plants, manufacturing facilities, chemical plants, and in other critical facilities and manufacturing applications. Early detection of a hazardous condition or equipment malfunction may allow an operator to take responsive actions earlier, to prevent expensive damage to equipment and facilities, stop a potentially dangerous condition, and maintain efficient and continuous operations.

Traditional methods of environmental condition monitoring depend solely on a single threshold detection. A detected hazardous level is compared with such threshold and an alarm warning is generated if the hazardous level is above the threshold for a certain period of time. There is no collaboration among the sensor devices in the monitoring network. If the threshold is set too high, the hazardous level may affect human safety yet the alarm is not triggered. If the threshold is set too low, interferences from nearby sources or a sensor device malfunction could trigger a false alarm, which interrupts normal operations. In addition, the traditional detection method uses a single sensor device or a plurality of discrete sensor devices to sample environmental conditions. Each sensor device works individually and there is no collaboration from one sensor device to another. A sensor device malfunction could trigger a false alarm when the hazardous level is low or never triggers the alarm even if the hazardous level is above the safety threshold. Particularly, the traditional method does not provide early warnings such that when the alarm is set off, the hazardous level may already be above the safety threshold, leaving little time for operators to react. Furthermore, environmental conditions, particularly hazardous conditions in areas such as a chemical plant, mining, oil refinery, etc., are dynamic and can change rather rapidly. A single threshold warning method cannot provide dynamic information about the hazardous condition and cannot provide early warnings to operators.

Therefore, there is a need for a method to accurately detect potential hazardous environmental conditions affecting human safety and provide early warning of such physical or environmental conditions, as well as to provide information on sensor device malfunctions.

### SUMMARY OF THE INVENTION

A sensor device network in the present invention comprises a network of geographically deployed autonomous sensor devices to monitor physical or environmental conditions in a work site. For example, in an oil pipeline application, the sensor devices can be deployed along the pipeline to detect leakages. The sensor devices are capable of detecting various environmental conditions such as temperature, humidity, pressure, pollutants, flammable gases, toxic vapors and so on, and transmitting the data to a central controller, where the data are stored and analyzed. Based on the data, the central controller can determine whether the hazardous level in the work site or near equipment exceeds a certain threshold or an equipment malfunction has occurred. If the hazardous level exceeds the threshold, the central controller can generate an alarm to warn the operators. Different sensor devices can be deployed at the same time to monitor various environmental conditions in a work site.

The present invention comprises many aspects and features of an environmental monitoring system using pattern recognition and distributed data processing technologies. In particular, the present invention provides a method to detect a trend of hazardous environmental conditions in the work site in order to provide early warnings to operators and to minimize false alarms due to interference from various sources or a sensor device malfunction. The present invention also provides a method to generate early warnings before a hazardous condition is above the threshold for human safety. Furthermore, the present invention provides a method to collaborate geographically deployed sensor devices in a sensor device network such that a malfunctioned sensor device will not affect the operation of the whole system and will minimize the risk of false alarms.

In one aspect of the invention, a sensor device network comprises a plurality of sensor devices geographically deployed for monitoring a pipeline or a plant, with the sensor devices being capable of acquiring data of the surrounding environmental conditions and communicating the data to a gateway through wireless channels, e.g., Bluetooth, wireless local access networks (WLAN), cellular networks, or other suitable methods of communication. The gateway comprises a data collection device capable of receiving the data sent from the sensor devices, and downloading the data to a central controller, where the data are stored and processed.

The invention may be embodied as a method to detect a change in hazardous environmental conditions including: sensing the hazardous condition and capturing data values indicative of the hazardous conditions; periodically determining a continuously increasing or decreasing trend in hazardous conditions; comparing the hazardous condition with a certain threshold, and generating an alarm if the hazardous level is greater than the corresponding threshold or removing an alarm if the hazardous level is lower than the corresponding threshold and the decreasing trend is detected.

The invention may be embodied as a method to collect environmental data, analyze the hazardous conditions, and provide feedback for the actuators in the network to perform various control actions.

The invention may be embodied as a method to locate the hazard leakage or malfunctioned devices.

The invention may further be embodied as a system comprising a plurality of sensor devices geographically deployed in a field to monitor the environmental hazardous conditions. In one aspect, the present invention may be embodied as a method to collaboratively process the environmental data received from a plurality of sensor devices. In other words, the method can jointly process the environmental data acquired from several neighboring sensor devices to detect the hazardous conditions.

Compared to the traditional method of environmental monitoring, the present invention offers at least two improvements. First, the trend of a hazardous condition is determined. A single data point is not used to determine whether to set off an alarm. The detection accuracy is considerably increased and false alarm rate is greatly reduced, such that the hazardous conditions can be detected in the very early stage to improve detection reliability. Second, a plurality of sensor devices in the sensor device network collaboratively work together to derive the global decision about the environmental conditions, so as to reduce the false alarm rate. It also helps the operators to identify the malfunctioning device to achieve easy management and maintenance.

### BRIEF DESCRIPTION OF DRAWINGS

FIG. 1 is an exemplary architecture of an environmental condition monitoring system with wireless sensor devices.

FIG. 2 illustrates a method for detecting a trend in an environmental condition.

FIG. 3 is a flowchart of detecting an environmental condition using a sensor device network.

FIG. 4 illustrates joint data processing of a trend and a threshold in an environmental condition monitoring system.

FIG. 5 is a schematic chart of sensor devices collaboration in an environmental condition monitoring system.

### DETAILED DESCRIPTION OF THE INVENTION

Generally, the present invention provides methods and systems to monitor and analyze environmental conditions within a wireless sensor devices network.

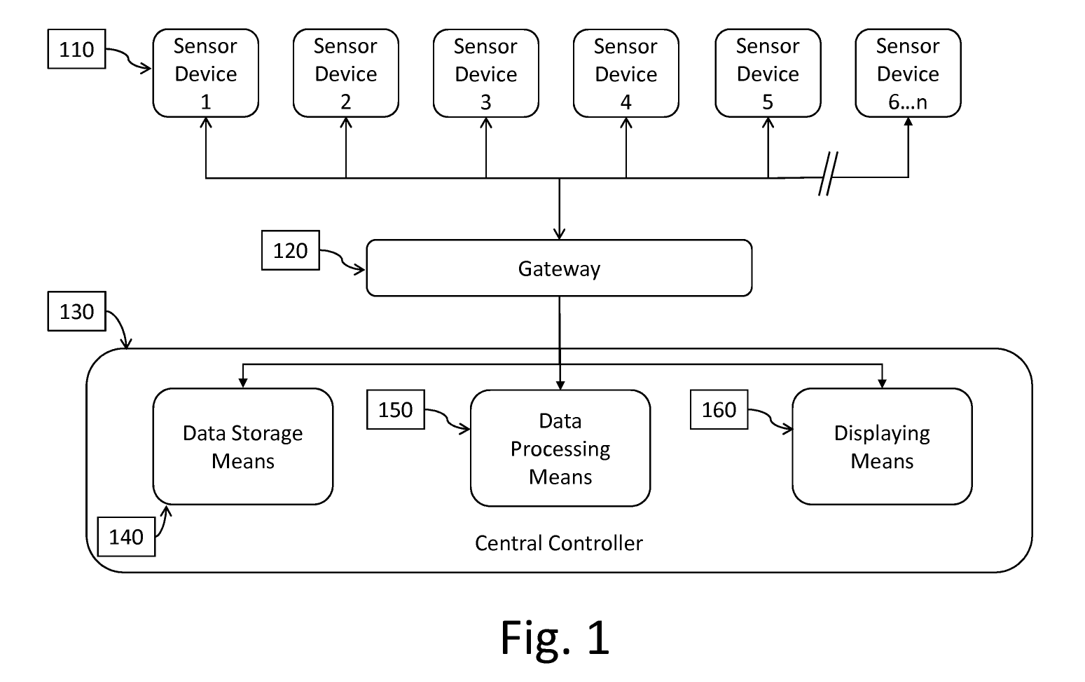

Referring to FIG. 1 now. FIG. 1 is an exemplary architecture of an environmental condition monitoring system with wireless sensor devices in the present invention. A plurality of sensor devices 110 are geographically deployed alongside a pipeline or in a work site to monitor the environmental conditions. For illustration purposes there are only five sensor devices 110 are shown in FIG. 1. The last sensor device is marked “6 . . . n”, indicating the number of sensor devices 110 in the networks is not limited to 5 but can be as many as required to monitor a particular environmental condition in the work site. These sensor devices 110 are capable of sensing environmental data such as temperature, pressure, humidity, volatile chemical concentration, etc. For example, the sensing devices 110 are in contact with volatile organic compounds and generate a response according the concentration of the volatile organic compounds in the surrounding environment. The sensor device response is normally transformed to a current or a voltage, the value of which corresponds to the concentration of the volatile organic compounds. The sensor devices 110 then transmit the transformed electronic data over wireless channels, i.e., WiFi, Bluetooth, cellular network, or other suitable methods of wireless communication through a gateway 120 to a central controller 130.

The central controller 130, including a processing unit and memory, typically comprises a data storage means 140, a data processing means 150, and a displaying means 160. Other peripherals can also be included and the list above is by no means inclusive. The central controller 130 may be a computer. The central controller 130 receives the electronic data from the sensor devices 110 via the gateway 120. The central controller 130 first stores the electronic data in the data storage means 140. The central controller 130 then sends the electronic data to the data processing means 150 for analysis. The results from the analysis are also stored in the data storage means 140. Any notifications to the operators, such as warnings or alarms, will be generated by the central controller 130 based on the analysis results and will be displayed on the displaying means 160.

The data storage means 140 includes at least three sections, a first one for storing associated electronic data from the sensor devices 110, a second one for storing analysis results based on the electronic data, and a third one for storing any communications, notifications, or warnings the central controller 130 generates to operators, as well as commands to actuators deployed alongside the sensor devices 110. The data storage means 140 may be a hard disk, a flash drive, a tape recorder, or any other suitable devices.

The displaying means 160 may be a computer monitor, a portable device such as a smartphone, a printer, or any other suitable devices.

By processing and analyzing the data communicated from the sensor devices 110, the central controller 130 derive a hazardous condition of the monitored environment and locate the hazard or the malfunctioning sensor device. The central controller 130 is also capable of sending commands to the actuators deployed alongside the sensor devices 110 to mitigate the hazardous condition. For example, if the central controller 130 determines pressure of a particular site is out of control, it may send a command to an actuator in that site to open a valve or by other means to release the pressure.

Also received from the sensor devices 110 are status data of the sensor devices themselves. These status data are also stored in the data storage means 140.

The central controller 130 commands data processing means 150 to analyze the received electronic data in real time to detect both a threshold and a trend within the electronic data to determine whether the environmental conditions warrant setting off an alarm or sending other notifications. The central controller 130 then sends such alarm or notifications to the displaying means 160 to notify the operators. The analysis results, along with the decisions made by the central controller 130 are also stored in the data storage means 140.

A unique feature of the present invention is that the hazardous condition is determined not by whether the sampled data are exceeding a pre-determined threshold (threshold detection). A trend in the sampled data must also be detected during a period of time (trend detection). Early warning can be obtained even if the data do not exceed the safety threshold but there is an uprising trend in the time domain. An alarm or other notifications are generated based on the comparison of both threshold detection and trend detection to improve reliability of the detection, as well as maintaining a continuous production in the work site.

Threshold detection

The sensed environmental conditions, such as temperature, pressure, humidity, etc., are transformed into a sensor devices output signal, such as a voltage or current, i.e., electronic data, which are subsequently transmitted to the central controller 110 via a gateway through wireless channels for data storage and processing. The sensor devices output signal is corresponding to the hazardous level in the monitored environment. The hazardous level monitored comprises temperature, pressure, humidity, concentration of volatile organic compounds, particles, etc. The electronic data, or a derivative of the electronic data, e.g., an average of several sets of the electronic data, may be compared with a certain threshold value to determine whether the hazardous level is higher than a tolerable level. The threshold value can be set based on various industrial standards from organizations such as International Standard Organization (“ISO”), American Society for Testing and Materials (“ASTM”), National Institute of Standard and Technology (“NIST”), Environmental Protection Agency (“EPA”), or any regulations or laws enacted by various federal, state, or local government agencies. If the hazardous level is higher than the threshold value, then the central controller 110 may set off an alarm, i.e., state “1”; otherwise, the central controller 110 may indicate that the environmental condition is normal, i.e., state “0”. The threshold value may be optimized in accordance with the sensor devices sensitivity, thermal and sensor device noises.

The threshold-based method is susceptible to pulse noises, external interferences, and sensor device malfunctions. Most importantly, once the detected level of the environmental condition is above threshold value, the environment may already be a high risk place in terms of human safety. There is little time for the operators to react to the hazardous conditions. The present invention presents two solutions to further enhance the accuracy, precision, and reliability in monitoring environmental conditions: trend detection and sensor devices collaboration, i.e., joint data processing by multiple sensor devices.

Trend Detection

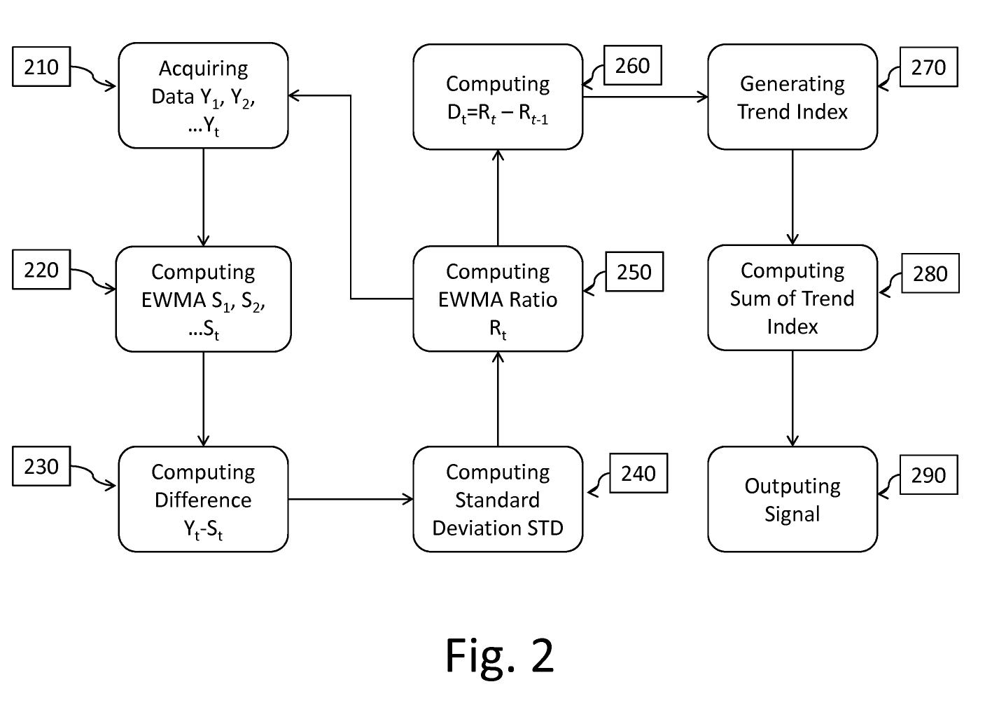

Referring to FIG. 2 now. FIG. 2 illustrates a method to detect a trend in a set of electronic data acquired from an environment. A leakage of hazardous materials, for example, usually follows a certain dispersion trend, which may be characterized by a mathematical model. For example, a leakage of flammable and/or toxic gas exhibits an increase in concentration over a certain period of time. The detection of the dispersion trend not only enables early detection of the hazardous leakage, but also can be used as one of the conditions for setting off an alarm to enhance the detection reliability. Although by no means an exclusive one, the following example tends to show the method for trend detection in the present invention.

A prediction model, e.g., exponentially-weighted-moving-average (“EWMA”) or autoregressive-moving-average (“ARMA”), is used as an estimate for the next new sample. Although EWMA and ARMA are shown as examples because they are the common ways to analyze dispersion data, they are for illustration purposes only and by no means exclusive. It must be understood that many other mathematical models can be used to achieve the same results.

In step 210, a series of data {Yₜ} are collected from the sensor devices at a certain time interval.

In step 220, an EWMA for the series of data {Yₜ} may be calculated recursively:

S₁=Y₁,

for t>1, Sₜ=α×Yₜ₋₁+(1−α)×Sₜ₋₁

wherein S₁ is the first EWMA; Y₁ is the first data value; α is a coefficient representing the degree of weighting; t is the time interval in which data are collected; Sₜ is the estimated EWMA at given time t; Yₜ₋₁ is the raw data value at time (t−1); Sₜ₋₁ is the EWMA at time (t−1).

In step 230, a difference between the raw data and the EWMA estimates (Yₜ−Sₜ) is calculated.

In step 240, a standard deviation (STDₜ) of a difference between the raw data and the EWMA estimate (Yₜ−Sₜ) is calculated:

$${STD}_{t} = \sqrt{\frac{{{Σ}_{1}^{t} ( {Y}_{t} - {S}_{t} )}^{2}}{t - 1}} at any given t$$

In step 250, a ratio (Rₜ) of the EWMA estimate (Sₜ) over the standard deviation above (STDₜ) is calculated:

$${R}_{t} = \frac{{S}_{t}}{{STD}_{t}}$$

In step 260, to capture the hill-climbing (increase) trend, a variance (Dₜ) between two successive ratio values (Rₜ) is calculated:

Dₜ=Rₜ−Rₜ₋₁ at given time t

In step 270, a trend index, dᵢ is generated. If Dₜ>0, then set dᵢ=1. If Dₜ=0, then set dᵢ=0. Else, set dᵢ=1, wherein dᵢ is the trend index.

In step 280, a sum Sᵢ of the values of dᵢ within a window of N (N=12 or so), i.e., d_{i-N+1} to dᵢ, is calculated.

If Sᵢ>M, wherein M is a predetermined threshold value, then there exists an increasing trend in the samples observed. The threshold value is predetermined based on experimental data. For example, M=6 may mean that there are 75% of probability that the trend is climbing. On the same token, a decreasing trend or no trend in the environmental condition may also be detected for the time interval. In step 290, the analysis results are used by the central controller to determine whether the environmental condition warrants an alarm to the operators. Likewise, a down trend can be detected if Sᵢ<M.

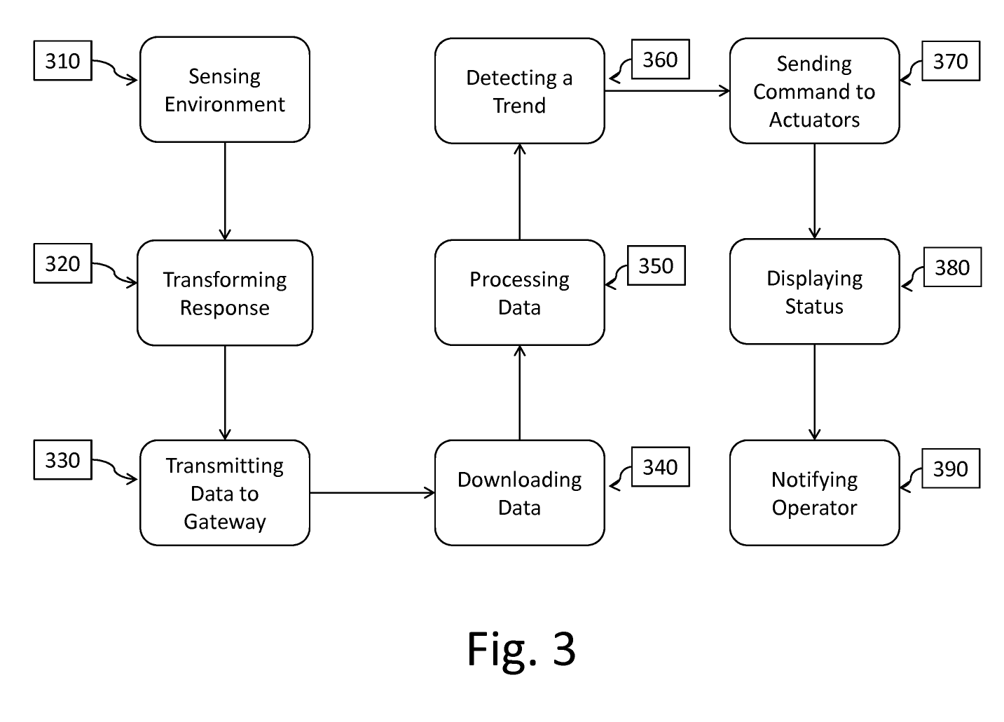

Referring to FIG. 3 now. FIG. 3 illustrates an exemplary method in the present invention on how to determine an environmental condition based on both a threshold value and a detected trend. Starting with step 310, the sensor devices sense their perspective environment at a certain time interval. The conditions sensed by the sensor devices can be thermal, physical, or physical, such as temperature, pressure, concentration of volatile organics, particles, or any other parameters that can be monitored in a work site. In step 320, these parameters are transformed to a sensor device response, i.e., electronic data, such as a voltage or a current, which value corresponds to the altitude of the parameter that is monitored. In step 330, a sensor device responses are transmitted periodically to a gateway through wireless channels such as WiFi, Bluetooth, wireless, or any other suitable communication methods. In step 340, the central controller downloaded the electronic data from the gateway and stores the data in a storage means. In step 350, a data processing means in the central controller processes and analyzes the electronic data. In step 360, the data processing means performs above-mentioned trend detection method to detect whether there is a trend in the incoming data. If there is a trend detected in the incoming data, the central controller must compare the threshold value to determine whether there is truly a hazardous condition in the monitored environment. In various situations, actuators can be deployed geographically alongside the sensor devices. In step 370, once a true hazardous condition is determined, the central controller can send commands to one or more actuators in the work site, in locations where the hazardous condition is detected and have these actuators take preliminary actions possible to mitigate the hazardous situation. For example, if a fire is detected alongside a pipeline, the central controller can send a command to an actuator deployed in the pipeline but before the fire, and order a shutdown of a safety valve before the fire such that the fire may not go out of control.

In other situations the central controller may determine there is a hill-climbing trend in the electronic data but hazard is not serious enough to impact the safety of the operators or the operation. Under these circumstances, in step 380, the central controller may just display a status of the operation to alert the operators while continue monitoring the situation.

In step 390, the central controller may also notify the operators by various means, such as setting off an alarm, sending a message to the operators' phones, or other suitable ways of communication.

Once a trend in the electronic data is detected, whether there is a true hazardous environmental condition cannot be determined by the trend detection alone. The central controller must also compare the trend with a pre-determined threshold value to determine whether the environmental condition is truly hazardous, or the environmental condition has not yet impacted human safety must an early warning must be issued to alert the operators. This is another important feature of the present invention, which is described in details in the following section.

Joint Data Processing

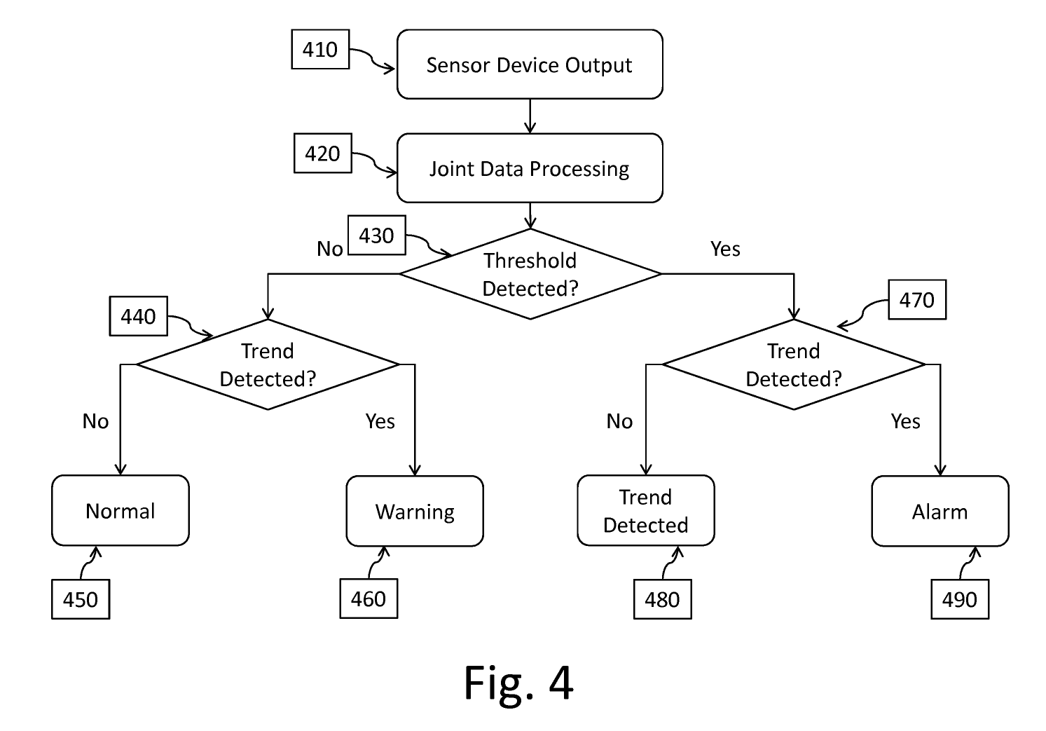

Referring to FIG. 4 now. A trend detection can be integrated with a threshold detection to enhance the detection reliability. FIG. 4 illustrates how the central controller jointly processes the threshold and trend detection results to identify the hazardous condition. Each of the sensor devices senses the hazardous condition in its vicinity and sends data to the central controller (step 410). The data processing means analyzes the electronic data from each individual sensor device and jointly process the data by detecting a trend in the data, then comparing the trend with a pre-determined threshold value (step 420). For example, if both outputs of the threshold detection and the trend detection are “0”, i.e., the detected hazardous condition is below the pre-determined threshold value (step 430) and there is no trend in the detection (step 440), the environmental conditions are normal (step 450). If the hazardous level is below the threshold value, “0”, while a trend is detected, “1”, the system will indicate that there may be a low concentration leakage but the hazardous level is tolerable (step 460). At this stage, although an alarm is unnecessary due to the reason the hazardous level has not exceeded the safety threshold, the climbing trend in the hazardous condition, especially the rate of the climbing, could be a concern to operators. An early warning on the increasing hazardous level may be given to alert the operators that the hazardous level may break the threshold and an investigation may be needed. The rate of the increase can also be evaluated such that a decision may be made by the operators to take further actions, such as evacuation of a work site, if the rate of increase is rapid that the hazardous level will break the threshold soon, for example. This can be crucial before it is too late to take actions when the hazardous level eventually breaks the safety threshold.

If a hazardous level is above the threshold, “1”, while a trend is not detected, “0”, (step 470), the abnormal condition is probably due to noise, external interferences, or a device malfunction (step 480). The system may indicate that a threshold is detected but there is no trend in the hazardous condition. The operators may make a decision whether to stop the operation and evacuate the site, or to continue the operation and monitoring the hazardous condition. Whereas, in the traditional threshold method alarm generating system, the operators must stop the operation and evacuate whenever the threshold is surpassed, regardless whether it is real or due to a sensor device malfunction.

If the hazardous level is greater than the threshold, “1”, and a climbing trend is also detected, “1”, the system can generate an alarm immediately to report the hazard leakage (step 490). In the traditional threshold method, it may be already too late to evacuate if the rate of leakage is so fast.

A down trend detection, “4”, can be also very useful. For example, during cleaning up process, although the hazardous level is still above the threshold, “1”, the trend may be decreasing, “−1”. The down trend, plus the rate of decrease of the hazardous level, may be used to evaluate the effectiveness of the clean-up to give out a general timeline estimate when the site can be returned to normal production. It may also indicate whether there are unfound leakage elsewhere in the production site, for example, if the rate of decrease is not rapid enough to correspond to the clean-up effort.

Sensor Devices Collaboration

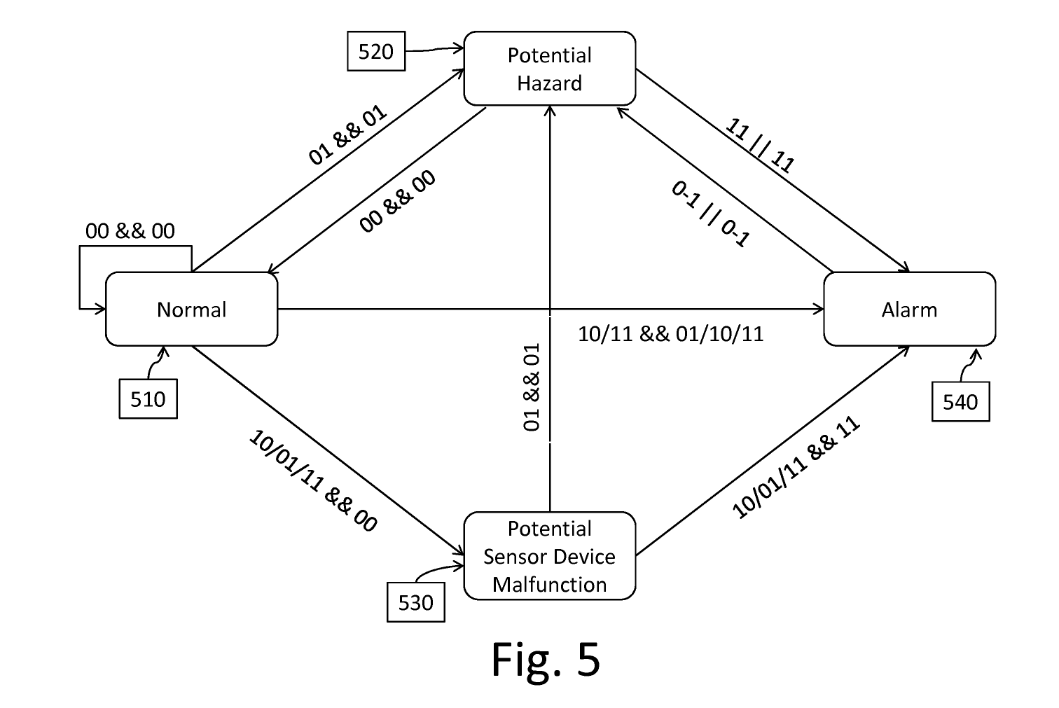

Referring to FIG. 5 now. A single sensor device may not reliably detect a dispersion trend or a hazardous level due to a number of reasons, such as a device malfunction, noise, or external interference. To prevent this problem, the present invention provides a method to collaborate multiple geographically deployed sensor devices with each other to enhance the detection reliability. FIG. 5 illustrates how multiple geographically deployed sensor devices work collaboratively to identify hazardous sources. In FIG. 5, “&&” is the logical operator “AND”, and “∥” is the logical operator “OR”. The value before the logical operator is the local sensor device output, i.e., threshold detection/trend detection, and the value after the logical operator is the neighboring sensor device's output. A local sensor device is referred to as any sensor devices in the sensor device network that is of the concern. A neighboring sensor device is any other sensor devices in the same sensor device network that is within the vicinity of the local sensor device.

For example, starting from the “Normal” state (step 510), if the local sensor device's output is “00”, which indicates a hazardous condition below a threshold and no trend detected, and all the neighboring sensor devices' outputs are “00”, then the environmental conditions are normal. The system keeps idling in the “Normal” state.

Starting from the “Normal” State (step 510), if the local sensor device and one of the neighboring sensor devices' outputs are “01” and “01”, i.e., both sensor devices detect the dispersion trend of the hazard leakage, although the hazardous level has not exceeded a pre-determined threshold level that warrants an alarm, the system may give out an early warning to the operators. The system migrates to the “Potential Hazard” state (step 520), indicating that there is a low concentration hazard leakage, i.e., reporting a potential hazardous condition that has not yet impacted human safety or the operation. The operators may continue monitoring the situation or decide to investigate the situation. After the leakage is fixed, the dispersion trend is not detected by the local sensor device or its neighboring sensor devices and the system will return to “Normal” state (step 510).

Starting from the “Potential Hazard” state (step 520), after the warning is generated, if either the local sensor device or one of its neighboring sensor devices detects that the hazardous level exceeds the threshold (i.e., the tolerable level), “11” and “11”, then the system generates an alarm. The system migrates to the “Generate Alarm” state (step 540). Over time, if both the local sensor device and the neighboring sensor devices detect a decreasing trend in the signal, “−1”, and the overall hazardous condition is below the threshold “0-1”, the system will return to “Potential Hazard” state (step 520).

Starting from the “Potential Hazard” state (step 520), if both the local and neighboring sensor devices have the outputs of “00”, i.e., no threshold detection and no trend detection, the system migrates back to the “Normal” state (step 510).

Starting from the “Normal” state (step 510), if the local sensor device detects some anomalies, i.e., the hazardous level greater than the threshold, or the dispersion trend detected, or both, “10/01/11”, but none of the neighboring devices detects any anomaly, “00”, the anomaly detected is probably due to a malfunction of the local sensor device. The system migrates to the “Potential Sensor Malfunction” state (step 530) to promote an operator investigation on the local sensor device.

Starting from the “Potential Sensor Malfunction” state (step 530), if after a certain time there are still no neighboring sensor devices reporting anomaly, a warning can be sent to the central controller to alert the operators that a possible sensor devices malfunction or other localized interference occurs in a specified location. The system stays in the “Potential Sensor Malfunction” state (step 530).

Starting from the “Potential Sensor Malfunction” state (step 530), if within a certain time period the neighboring sensor devices also detect a dispersion trend, “01” and “01”, then the system generates a warning and the system migrates to the “Potential Hazard” state (step 520).

Starting from the “Potential Sensor Malfunction” state (step 530), if within a certain time period the neighboring sensor devices also detect a hazardous level greater than the threshold, “11”, the system generates an alarm and migrates to the “Generate Alarm” state (step 540).

Starting from the “Generate Alarm” state (step 540), if after a certain time period, the local and neighboring sensor devices detect that the hazardous level is lower than the threshold and a decreasing trend is detected, “0-1” and “0-1”, the alarm may be downgraded to a “Potential Hazard” to indicate a low concentration leakage (step 520).

The system operator can always reset the system into the “Normal” state after conducting some manual checks over a malfunctioned device in the system.

If a hazard is detected, its location can be determined by one or more sensor devices that first report the trend detection and/or the threshold detection. The central controller can send a command through the wireless channel to the corresponding actuator in the network so that the corresponding actuator can respond to the hazardous condition immediately, i.e., turning on water spay extinguishing systems, shutting down switches of pipelines, blinking alarming lights, etc.

What is claimed is:

1. A method for monitoring environmental condition, comprising,
sensing an environment condition by at least one sensor device deployed in a network of a plurality of geographically deployed sensor devices;
transforming a sensor device response to electronic data;
transmitting said electronic data to a gateway;
downloading said electronic data to a central controller; whereby said electronic data are stored and analyzed;
detecting a trend in said electronic data;
displaying a status of said environment condition on a displaying means;
sending a command to a plurality of geographically deployed actuators, whereby the actuators respond to said environmental condition; and
notifying an operator.

2. The environmental condition monitoring method in claim 1, further comprising generating a threshold index.

3. The environmental condition monitoring system in claim 1, further comprising generating a trend index.

4. The environmental condition monitoring method in claim 1, further comprising displaying a warning on said displaying means.

5. The environmental condition monitoring method in claim 1, further comprising activating an alarm on said displaying means.

6. The method for monitoring environmental condition, wherein said actuators are deployed alongside said sensor devices.

7. A method for monitoring environmental condition, comprising,
sensing an environment condition by at least one sensor device deployed in a network of a plurality of geographically deployed sensor devices;
transforming a sensor device response to electronic data;
transmitting said electronic data to a gateway;
downloading said electronic data to a central controller; whereby said electronic data are stored and analyzed;
detecting a trend in said electronic data;
displaying a status of said environment condition on a displaying means;
sending a command to a plurality of geographically deployed actuators, whereby the actuators respond to said environmental condition; and
notifying an operator.

8. The environmental condition monitoring method in claim 7, further comprising computing at least one moving average of said electronic data.

9. The environmental condition monitoring method in claim 7, further comprising computing at least one difference between said electronic data and said moving average.

10. The environmental condition monitoring method in claim 7, further comprising computing at least one standard deviation of said difference.

11. The environmental condition monitoring method in claim 7, further comprising computing at least one ratio of said moving average to said standard deviation.

12. The environmental condition monitoring method in claim 7, further comprising computing at least one variance between two said ratios.

13. The environmental condition monitoring method in claim 7, further comprising generating at least one trend index.

14. The environmental condition monitoring method in claim 7, further comprising computing a sum of said trend index.

15. The environmental condition monitoring method in claim 7, further comprising comparing said sum to a threshold value.

16. The environmental condition monitoring method in claim 7, further comprising detecting a trend in said electronic data.

17. The environmental condition monitoring method in claim 8, wherein said moving average is an exponentially-weighted moving average.

18. The environmental condition monitoring method in claim 8, wherein said moving average is an autoregressive moving average.

19. A method for monitoring environmental condition, comprising,
sensing an environmental condition by at least one sensor device deployed in a network of a plurality of geographically deployed sensor devices;
transforming a sensor device response to electronic data;
transmitting said electronic data to a gateway;
downloading said electronic data to a central controller; whereby said electronic data are stored and analyzed;
detecting a trend in said electronic data;
displaying a status of said environment condition on a displaying means;
sending a command to a plurality of geographically deployed actuators, whereby the actuators respond to said environmental condition; and
notifying an operator.

20. The environmental condition monitoring method in claim 19, further comprising acquiring a first set of data from a local sensor device.

21. The environmental condition monitoring method in claim 19, further comprising deriving a first environmental condition from said first set of data.

22. The environmental condition monitoring method in claim 19, further comprising acquiring at least one additional set of data from at least one neighboring sensor device.

23. The environmental condition monitoring method in claim 19, further comprising deriving a second environmental condition from said additional set of data.

24. The environmental condition monitoring method in claim 19, further comprising comparing said second environmental condition from said first environmental condition.

25. The environmental condition monitoring method in claim 19, further comprising displaying a warning on said displaying means.

26. The environmental condition monitoring method in claim 19, further comprising activating an alarm on said displaying means.

27. The environmental condition monitoring method in claim 19, further comprising displaying a malfunction status of said local sensor device on said displaying means.
